(19) United States
(12) Patent Application Publication
(10) Pub. No.: US 2011/0049394 A1
(43) Pub. Date: Mar. 3, 2011

(54) IONIZING DISINFECTANT SURFACE

(76) Inventor: L. Pierre de Rochemont, Austin, TX (US)

(21) Appl. No.: 12/873,974

(22) Filed: Sep. 1, 2010

Related U.S. Application Data
(60) Provisional application No. 61/238,818, filed on Sep. 1, 2009.

(51) Int. Cl. G21G 4/00; B05D 5/00

(52) U.S. Cl. 250/493.1; 427/6

(57) ABSTRACT

A disinfectant surface provides a material layer and alpha-particle emitters embedded in the material layer and located in proximity to a surface of the material layer for emitting alpha particles through the surface for disinfecting any matter contacting the surface

### CROSS REFERENCE TO RELATED APPLICATIONS

This application claims priority from U.S. Provisional Patent Application Ser. No. 61/238,818, filed Sep. 1, 2009 and incorporated herein by reference in its entirety.

### FIELD OF THE INVENTION

The present invention generally relates to devices having ionizing radiation, and in particular to such devices which are used for disinfection purposes.

### BACKGROUND OF THE INVENTION

In various practical settings there are work surfaces, such as table-like support surfaces in the food processing industry, or means useful in artificial life support, such as tracheal tubes or feeding tubes, that need to be maintained in a sterile condition and resistant to bacteriological film growth for health and safety reasons but cannot be easily or continuously disinfected.

In view of the above, it would be beneficial to have surfaces that reduce the need for disinfectant processes to improve the efficiency of the industrial processes that use such surfaces.

### SUMMARY OF THE INVENTION

In one embodiment, the present invention provides a disinfectant surface, comprising a material layer and alpha-particle emitters embedded in the material layer and located in proximity to a surface of the material layer for emitting alpha particles through the surface for disinfecting any matter contacting the surface.

The alpha-particle emitters may be radium. The surface may further comprise a shielding layer formed on the surface to control the range of emission of the alpha particles. The material layer may be ceramic or metal. The material layer may be formed on a substrate.

Another embodiment of the present invention provides a method for manufacturing a disinfectant surface, comprising the step of forming a metal or ceramic layer with alpha-particle emitters located in proximity to a surface thereof using liquid chemical deposition. The constituents of the metal or ceramic layer and the alpha-particle emitters may be simultaneously formed.

### BRIEF DESCRIPTION OF THE DRAWING

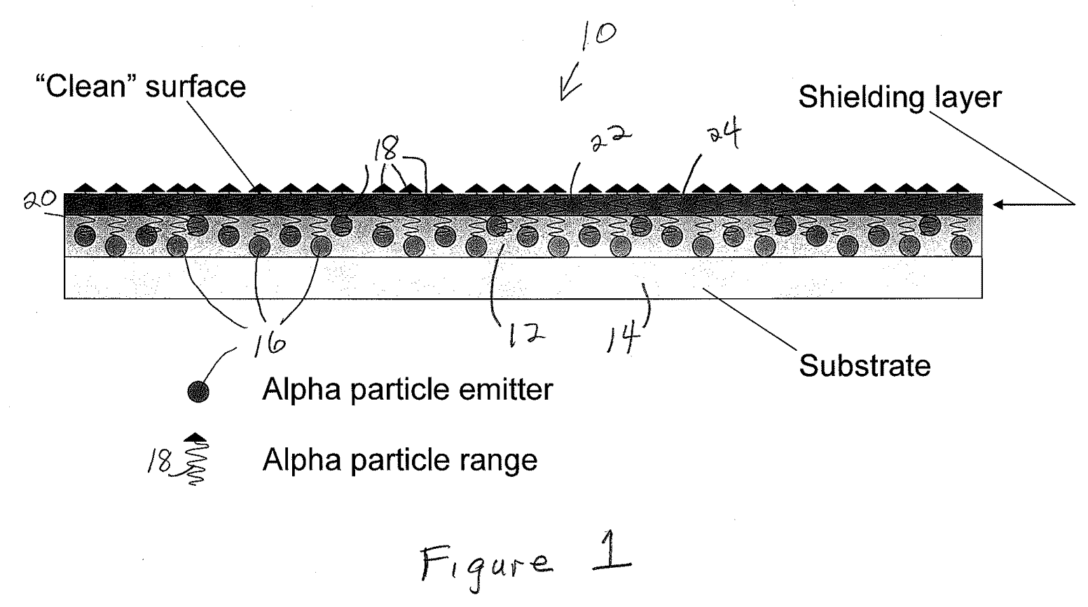

The present invention is illustratively shown and described in reference to the accompanying FIG. 1, which is a sectional side view of a device constructed with an ionizing disinfectant surface.

### DETAILED DESCRIPTION OF THE DRAWINGS

FIG. 1 is a sectional side view of a piece of material 10 having a material layer 12, which is optionally formed on a substrate 14. Embedded within material layer 12 are number alpha-particle emitters 16, which are each represented by an alpha particle range 18. Alpha-particle emitters 16 are located either adjacent or sufficiently close to a contact surface 20 of material layer 12 such that the alpha particle range 18 extends past contact surface 20. This location allows alpha particles to reach anything in contact with contact surface 20 for purposes of disinfection. Alpha-particle emitters 16 are optionally show to be located at different depths with respect to contact surface 20, but may also be located at approximately the same depth.

Surface 20 is optionally shown to have a shielding layer 22, which creates an alternative contact surface 24. The alpha particle range 18 is shown to extend slightly beyond alternative contact surface 24. In this manner, shielding layer 22 may be used to more precisely adjust the distance that the alpha particle range 18 extends beyond the contact surface of the device 10. It may optional be used for creating a customized surface for a particular purpose.

The present invention may be constructed using the Liquid Chemical Deposition methods disclosed in U.S. patent application Ser. No. 12/843,112, filed Jul. 26, 2010 entitled LIQUID CHEMICAL DEPOSITION APPARATUS AND PROCESS AND PRODUCTS THEREFROM, the contents of which are hereby incorporated by reference herein. Using those methods, the material layer 12 may easily be formed of metal or ceramic and applied to a substrate 14. Alpha-particle emitters 16 may be incorporated into material layer 12 during its formation, and located at any desired depth from the surface 20 of material layer 12. Any suitable alpha-particle emitters, such as radium, may be used. The intrinsic value for using alpha-particles as the ionizing source to disinfect a surface 24 from bacteriological contamination is that the range (penetration depth) of alpha particles is limited to a couple of millimeters in air, and to shorter distances in solids. As such, alpha-particle radiation is ideal in applications that require a surface to be irradiated, but for adjacent tissue to remain largely unharmed. In this manner, shielding layer 22 may be used to limit alpha-particle penetration to a mere microns past alternative contact surface 24.

The present invention is illustratively described above in reference to the disclosed embodiments. Various modifications and changes may be made to the disclosed embodiments by persons skilled in the art without departing from the scope of the present invention as defined in the appended claims.

What is claimed is:

1. A disinfectant surface, comprising:
a material layer; and
alpha-particle emitters embedded in the material layer and located in proximity to a surface of the material layer for emitting alpha particles through the surface for disinfecting any matter contacting the surface.

2. The surface of claim 1, wherein the alpha-particle emitters are radium.

3. The surface of claim 1, further comprising a shielding layer formed on the surface to control the range of emission of the alpha particles.

4. The surface of claim 1, wherein the material layer is ceramic or metal.

5. The surface of claim 1, wherein the material layer is formed on a substrate.

6. A method for manufacturing a disinfectant surface, comprising the step of forming a metal or ceramic layer with alpha-particle emitters located in proximity to a surface thereof using liquid chemical deposition.

7. The method of claim 6, wherein constituents of the metal or ceramic layer and the alpha-particle emitters are simultaneously formed.
